(19) United States
(12) Patent Application Publication
(10) Pub. No.: US 2026/0045534 A1
(43) Pub. Date: Feb. 12, 2026

(54) SECONDARY BATTERY AND A BATTERY MODULE INCLUDING THE SAME

(71) Applicant: SAMSUNG SDI CO, LTD., Yongin-si (KR)

(72) Inventor: Taewoong JANG, Yongin-si (KR)

(21) Appl. No.: 19/008,718

(22) Filed: Jan. 3, 2025

(30) Foreign Application Priority Data
Aug. 6, 2024 (KR) 10-2024-0104358

(51) Int. Cl. H01M 10/04; H01M 50/109; H01M 50/595

(52) U.S. Cl. CPC H01M 10/0431; H01M 10/0427; H01M 50/109; H01M 50/595

(57) ABSTRACT

A secondary battery includes a case, an electrode assembly accommodated in the case, the electrode assembly including a winding of a first electrode, a second electrode, a separator interposed between the first electrode and the second electrode, and a tape surrounding an outermost portion of the electrode assembly along a winding direction, the tape comprising a first protrusion portion protruding in a first direction toward a top of the electrode assembly and a second protrusion portion connected to the first protrusion portion, the second protrusion portion protruding in a second direction toward a bottom of the electrode assembly, wherein the first protrusion portion and the second protrusion portion are alternated, an inner side of the first protrusion portion is positioned above a reference line, and an inner side of the second protrusion portion is positioned below the reference line, and the reference line divides the tape in a width direction.

### CROSS-REFERENCE TO RELATED APPLICATION

This present application claims priority to and the benefit under 35 U.S.C. § 119(a)-(d) of Korean Patent Application No. 10-2024-0104358, filed on Aug. 6, 2024, in the Korean Intellectual Property Office, the entire disclosure of which is incorporated herein by reference.

### BACKGROUND

### 1. Field

Embodiments relate to a secondary battery and a battery module including the same.

### 2. Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, including a case, an electrode assembly accommodated in the case, the electrode assembly including a winding of a first electrode, a second electrode, and a separator interposed between the first electrode and the second electrode, and a tape surrounding an outermost portion of the electrode assembly along a winding direction, the tape including a first protrusion portion protruding in a first direction toward a top of the electrode assembly and a second protrusion portion connected to the first protrusion portion, the second protrusion portion protruding in a second direction toward a bottom of the electrode assembly, wherein the first protrusion portion and the second protrusion portion are alternated, an inner side of the first protrusion portion is positioned above a reference line, and an inner side of the second protrusion portion is positioned below the reference line, and the reference line divides the tape in a width direction.

Each of the first direction and the second direction may be perpendicular to the winding direction of the electrode assembly.

A shape of an outer side of the first protrusion portion and the reference line, and a shape of the inner side of the first protrusion portion and the reference line may correspond with each other.

The shape of the outer side of the first protrusion portion and the reference line, and the shape of the inner side of the first protrusion portion and the reference line may be any one of a triangular shape, a rectangular shape, a trapezoidal shape, and a semicircular shape.

A shape of an outer side of the first protrusion portion and the reference line, and a shape of an inner side of the first protrusion portion and the reference line may be different from each other.

The shape of the outer side of the first protrusion portion and the reference line may be trapezoidal, and the shape of the inner side of the first protrusion portion and the reference line may be triangular.

The shape of the outer side of the first protrusion portion and the reference line may be triangular, and the shape of the inner side of the first protrusion portion and the reference line may be trapezoidal.

The tape may include a substrate layer and an inner adhesive layer, the inner adhesive layer being between the electrode assembly and the substrate layer.

The tape may further include an outer adhesive layer between the case and the substrate layer.

The substrate layer may include a polymer foam.

The polymer foam may include at least one of polyurethane resin, polyolefin resin, styrenic block copolymer, ethylene copolymer, acrylic block copolymer, acrylic acid ester copolymer, and halogenated polymer.

The inner adhesive layer may further include a portion other than a portion overlapping the substrate layer among entire areas between a top end of the first protrusion portion and a bottom end of the second protrusion portion.

The outer adhesive layer may further include a portion other than a portion overlapping the substrate layer among entire areas between a top end of the first protrusion portion and a bottom end of the second protrusion portion.

The tape may surround the electrode assembly once, and opposite ends of the tape may be in contact with each other.

The tape may surround the electrode assembly at least once and has an area where the tape partially overlaps itself.

The area where the tape partially overlaps itself may be provided in plurality.

The secondary battery may be a coin cell, a cylindrical cell, or a pin cell.

The reference line may divide the tape in half in a width direction.

A shape of the first protrusion portion may be different than a shape of the second protrusion portion.

A battery module including a plurality of the secondary battery, resulting in secondary batteries, wherein the secondary batteries are electrically connected to each other.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings.

FIG. 1 illustrates a cross-sectional view of a secondary battery according to one or more embodiments of the present disclosure.

FIG. 2 illustrates a perspective view showing the electrode assembly according to one or more embodiments of the present disclosure.

FIG. 3 illustrates a diagram for describing a cross section of a tape according to one or more embodiments of the present disclosure.

FIG. 4 illustrates a perspective view showing a tape according to one or more embodiments of the present disclosure.

FIG. 5 illustrates a perspective view showing a tape according to one or more embodiments of the present disclosure.

FIG. 6 illustrates a perspective view showing a tape according to one or more embodiments of the present disclosure.

FIG. 7 illustrates a perspective view showing a tape according to one or more embodiments of the present disclosure.

FIG. 8 illustrates a perspective view showing a tape according to one or more embodiments of the present disclosure.

FIG. 9 illustrates a diagram for describing an overlapping portion of a tape according to one or more embodiments of the present disclosure.

FIG. 10 illustrates a diagram for describing an overlapping portion of a tape according to one or more embodiments of the present disclosure.

FIG. 11 illustrates a flowchart showing a method for manufacturing a tape for an electrode assembly according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components“.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

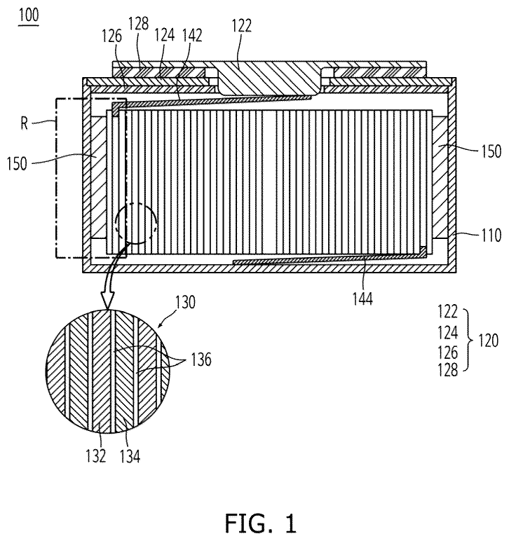

FIG. 1 illustrates a cross-sectional view of a secondary battery according to one or more embodiments of the present disclosure.

In the present disclosure, a secondary battery 100 may refer to a secondary battery including a wound electrode assembly 130. For example, the secondary battery 100 may be a coin cell, a cylindrical cell, or a pin-type cell, but may also vary. Hereinafter, a case where the secondary battery 100 is an ultra-small cell, such as a coin cell, is described as an example.

A coin cell or a button cell may be a battery in the shape of a thin coin or a button, and may refer to a battery in which a height to diameter (height/diameter) ratio is 1 or less. Because the coin cell or the button cell is mainly cylindrical, the horizontal cross-section thereof is circular, but the horizontal cross-section thereof may be oval or polygonal. At this time, the diameter may refer to the maximum distance based on the horizontal direction of the battery, and the height may refer to the maximum distance (the distance from the flat bottom surface to the flat top surface) based on the vertical direction of the battery.

Referring to FIG. 1, the secondary battery 100 may include an electrode assembly 130, a case 110 that accommodates the electrode assembly 130 and an electrolyte therein, as well as a cap assembly 120 that is joined to an opening of the case 110 to seal the case 110. The cap assembly 120 may include a cap plate 124 joined to the opening of the case 110, a terminal plate 122 insulated from the cap plate 124 by an insulating layer 128, and an insulating member 126 positioned between the electrode assembly 130 and the cap plate 124 within the case 110.

In an embodiment, the case 110 may accommodate the electrode assembly 130 and the electrolyte, and may configure the external appearance of the secondary battery together with the cap assembly 120. The case 110 may include an approximately cylindrical body portion and a bottom portion connected to one side of the body portion.

In addition, the case 110 may be formed of a metal, such as aluminum, an aluminum alloy, or nickel-plated steel. However, any material that is commonly used in the art may be used without limitation as long as the material is chemically resistant to the electrolyte and is conductive.

The terminal plate 122 may be electrically connected to the electrode assembly 130. The terminal plate 122 may be physically connected to the electrode assembly 130 through an electrode tab 142 or the like. The terminal plate 122 may be electrically insulated from the cap plate 124 by the insulating layer 128. In addition, the terminal plate 122 may be bonded to the cap plate 124 by the insulating layer 128. In this manner, the terminal plate 122 may serve as an electrode terminal. Referring to FIG. 1, the terminal plate 122 may include a lower protrusion portion and an upper flange portion, and the protrusion portion may be inserted into an opening formed in the center of the cap plate 124. In addition, the insulating member 126 may be disposed so that the electrode assembly 130 or the electrode tab 142 connected to the electrode assembly 130 may be insulated from the cap plate 124. For example, as illustrated in FIG. 1, the electrode tab 142 of the electrode assembly 130 may be in contact with the protrusion portion of the terminal plate 122. Accordingly, the insulating member 126 may be disposed between the cap plate 124 and the electrode assembly 130 except for the portion where the protrusion portion of the terminal plate 122 is positioned.

In an embodiment, in the electrode assembly 130 accommodated in the case 110, a laminate including a first electrode 132, a second electrode 134, and a separator 136 interposed between the first electrode 132 and the second electrode 134 may be wound in a jelly-roll form. For example, the electrode assembly 130 may be a wound electrode assembly having a structure in which long sheet-shaped positive and negative electrodes are wound with the separator 136 interposed therebetween. For example, the wound electrode assembly may be formed in a cylindrical or oval structure in cross section by winding the long sheet-shaped positive and negative electrodes in a dense state. Referring to FIG. 1, the widthwise lengths of the first electrode 132, the second electrode 134, and the separator 136 are shown to be the same size, but this is a simplified schematic representation of the electrode assembly 130, and the sizes may be varied.

The first electrode 132 may include a first substrate and a first active material layer positioned on the first substrate. In a first uncoated portion of the first substrate where the first active material layer is not applied, the first electrode tab 142 or a first lead tab may extend outward. The first electrode tab 142 or the first lead tab may be electrically connected to the cap assembly 120. Specifically, the first electrode tab 142 or the first lead tab may be electrically connected to the terminal plate 122. In this case, the terminal plate 122 may protrude outside the secondary battery 100 and serve as a first electrode terminal.

The second electrode 134 may include a second substrate and a second active material layer coated on the second substrate. In a second uncoated portion of the second substrate where the second active material layer is not applied, a second electrode tab 144 or a second lead tab may extend downward (in the orientation of FIG. 1). The second electrode tab 144 or the second lead tab may be electrically connected to the case 110. In this case, the case 110 may serve as a second electrode terminal.

As illustrated in FIG. 1, in the electrode assembly 130, the first electrode tab 142 and the second electrode tab 144 may extend in opposite directions. In other embodiments, the first lead tab and the second lead tab in the electrode assembly 130 may extend in the same direction. In addition, the first electrode 132 may function as a positive electrode. In this case, the first substrate may include, for example, aluminum foil, and the first active material layer may include, for example, a transition metal oxide. Meanwhile, the second electrode 134 may function as a negative electrode. In this case, the second substrate may include, for example, copper foil or nickel foil, and the second active material layer may include, for example, graphite. In other embodiments, the first electrode 132 may function as a negative electrode and the second electrode 134 may function as a positive electrode.

The separator 136 may function to prevent a short circuit from occurring between the first electrode 132 and the second electrode 134 while allowing movement of lithium ions. The separator 136 may include, for example, a polyethylene film, a polypropylene film, a polyethylene-polypropylene film, or the like.

The electrode assembly 130 of the secondary battery 100 according to one or more embodiments of the present disclosure may have a tape 150 attached thereto. The tape 150 may surround the outermost portion of the electrode assembly 130, as described above, roughly along the winding direction of the electrode assembly 130. The tape 150 may be disposed between the outermost part of the electrode assembly 130 and the case 110. In an embodiment, the tape 150 may be attached to the outermost portion of the electrode assembly 130 and may or may not be in contact with the case 110. The tape 150 may function to insulate the electrode assembly 130 from the case 110. In addition, the tape 150 may function to fix the wound first substrate or second substrate of the electrode assembly 130 so as not to be released. In an embodiment, the tape 150 may be in a zigzag shape, and the shape and material of the tape 150 is described below.

In an embodiment, the wound electrode assembly 130 as described above may be finished with the first substrate or the second substrate. Accordingly, one surface of the tape 150 may be attached to the outer surface of the first substrate or the second substrate. In addition, the other surface of the tape 150 may be attached to or in contact with the case 110.

A battery module according to an embodiment of the present disclosure may include a plurality of secondary batteries 100 as described above, which are electrically connected to each other. The secondary battery 100 may have the tape 150 attached to thereto as described above, and thus, cracks may be reduced in the electrode substrate. Accordingly, the secondary battery 100 and the battery module including the same may reduce the risk of fire due to cracks in the electrode assembly 130.

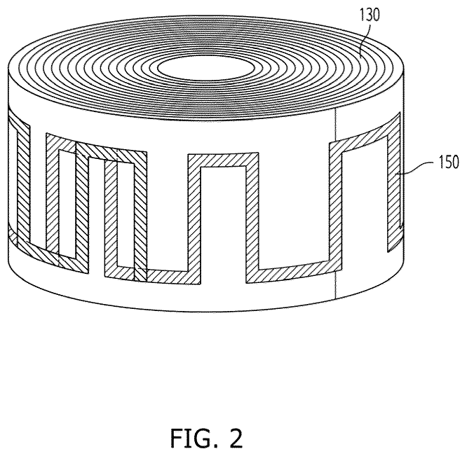

FIG. 2 illustrates a perspective view showing the electrode assembly according to one or more embodiments of the present disclosure.

The wound electrode assembly is relatively easy to manufacture and may have high energy density per weight. However, stress caused by expansion and contraction of the electrode during charging and discharging may accumulate in the electrode assembly 130. Specifically, in a case where a charge/discharge cycle is performed, the electrode sheets are repeatedly charged and discharged several times, and accordingly, the electrode sheets may repeatedly expand and contract. At this time, natural expansion and contraction of the electrode sheets may not be easy due to the tape 150 surrounding the outermost portion of the electrode assembly 130. In a case where the resulting stress accumulation exceeds a certain limit, cracks may occur and expand in the electrode sheet.

To solve the problems described above, the tape 150 attached to the outermost portion of the electrode assembly 130 may include a first protrusion portion protruding in a first direction toward the top of the electrode assembly 130 and a second protrusion portion connected to the first protrusion portion and protruding in a second direction toward the bottom of the electrode assembly 130, as illustrated in FIG. 2. The top and the bottom are for convenience of explanation based on the electrode assembly 130 illustrated in FIG. 2, and the positions thereof may change in a case where the secondary battery rotates left and right or up and down.

In addition, the first protrusion portion and the second protrusion portion may be alternately disposed. In the present disclosure, the first protrusion portion and the second protrusion portion may be repeatedly disposed to a length sufficient to surround the outermost portion of the electrode assembly 130 at least once. The alternating arrangement may be such that neighboring protrusion portions protrude in approximately opposite directions. In other embodiments, the neighboring protrusion portions may protrude in the same direction, and the neighboring protrusion portions protrude in opposite directions with one protrusion portion therebetween. Hereinafter, a case where the neighboring protrusion portions protrude in approximately opposite directions is described as an example.

According to an embodiment, the first direction, which is the protrusion direction of the first protrusion portion, and the second direction, which is the protrusion direction of the second protrusion portion, may be each perpendicular to the winding direction of the electrode assembly 130. The winding direction of the electrode assembly 130 may refer to the direction in which the first substrate or the second substrate is wound based on the winding axis.

In an embodiment, the location where the tape 150 is attached to the outermost portion of the electrode assembly 130 may be between the top end and the bottom end along the height of the electrode assembly 130. For example, the attachment location of the tape 150 may be approximately at the center of the height of the electrode assembly 130. However, the attachment location of the tape 150 may be a location where the wound first substrate or second substrate of the electrode assembly 130 is not released.

In an embodiment, the thickness of the tape 150 may be a thickness that provides a gap sufficient to insulate the case and electrode assembly 130 from each other. Specifically, the thickness of the tape 150 may be equal to or thinner than the gap between the outermost portion and the case in a scenario where the electrode assembly 130 is expanded to the maximum during the life of the secondary battery. As described below, the tape 150 may include a substrate layer and an adhesive layer, and the thickness of the tape 150 as described above may be formed by adjusting the thicknesses of the substrate layer and the adhesive layer according to the size of the case and electrode assembly 130 of the secondary battery.

Referring to FIG. 2, the vertical line shown in the electrode assembly 130 may refer to the end of the first substrate or the second substrate at the portion where the winding of the first substrate or the second substrate is finished. In one or more embodiments, as illustrated in FIG. 2, the portion where the tape 150 is finished and the portion where the first substrate or the second substrate is finished may not coincide with each other. However, the portion where the tape 150 is finished and the portion where the first substrate or the second substrate is finished may approximately coincide with each other. The tape 150 may partially overlap at the portion where the first substrate or the second substrate is finished, thereby fixing the wound substrate so as not to be released.

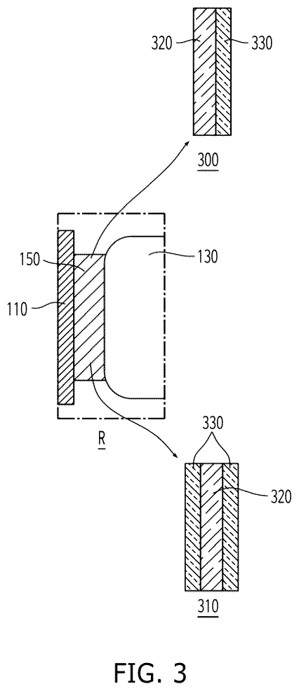

FIG. 3 illustrates a diagram for describing a cross section of a tape according to some embodiments of the present disclosure. FIG. 3 illustrates a schematic enlarged view of a region R in FIG. 1.

In an embodiment, the tape 150 may include a substrate layer 320 and an inner adhesive layer 330. Specifically, the inner adhesive layer 330 may be disposed between the electrode assembly 130 and the substrate layer 320.

In an embodiment, the tape 150 may include the inner adhesive layer 330 disposed on one surface of the substrate layer 320 and the outer adhesive layer 330 disposed on the other surface of the substrate layer 320. The inner adhesive layer 330 may be disposed between the electrode assembly 130 and the substrate layer 320, and the outer adhesive layer 330 may be disposed between the case 110 and the substrate layer 320. In an embodiment, the thickness of the adhesive layer 330 may be thinner than the thickness of the substrate layer 320.

According to an embodiment, the substrate layer 320 may be formed by appropriately selecting a crosslinking agent and polymers having water resistance or oil resistance. The polymers with long, linear molecular structures may have difficulty in interacting with each other. Accordingly, the cross-linking agent may create chemical bonds between linear molecules, allowing the linear molecules to interact with each other. The polymers may be linked to each other through the crosslinking agent to form a network structure. Accordingly, the strength and elasticity of the polymer material may be improved, and it may become an insoluble material with a three-dimensional structure. Accordingly, in a scenario where the tape 150 is accommodated in the case 110 together with the electrode assembly 130, reliability regarding chemical resistance with the electrolyte may be secured, and elasticity is developed according to expansion and contraction of the electrode assembly 130, and thus, the tape 150 may not be damaged.

The polymer may refer to polymer foam. The polymer foam may include at least one of polyurethane resin, polyolefin resin, styrenic block copolymer, ethylene copolymer, acrylic block copolymer, acrylic acid ester copolymer, and halogenated polymer.

The polyurethane resin may be a polymer of polyol and polyfunctional isocyanate. The polyolefin resin may be polyethylene, polypropylene, etc. The styrenic block copolymer may be styrene-butadiene-styrene-block copolymer polymer or styrene-isobutylene-styrene-block copolymer polymer. The ethylene copolymer may be ethylene-vinyl acetate, ethylene-ethyl acrylate, ethylene-methyl methacrylate, etc. The acrylic block copolymer may be methyl methacrylate-butyl acrylate-methyl methacrylate, etc. The acrylic acid ester copolymer may be a copolymer of 2-ethylhexyl acrylate or methyl acrylate. The halogenated polymer may be polyvinyl chloride, etc.

The base polymer may be a polyurethane resin with excellent flexibility and impact resistance so as not to be damaged by expansion and contraction of the electrode assembly 130 and not to cause cracks in the electrode substrate to which the tape 150 is attached.

The adhesive layer 330 according to an embodiment may include an acrylate adhesive composition. However, any adhesive that is commonly used in the art may be used without limitation as long as the adhesive has adhesiveness and chemical resistance to the electrolyte.

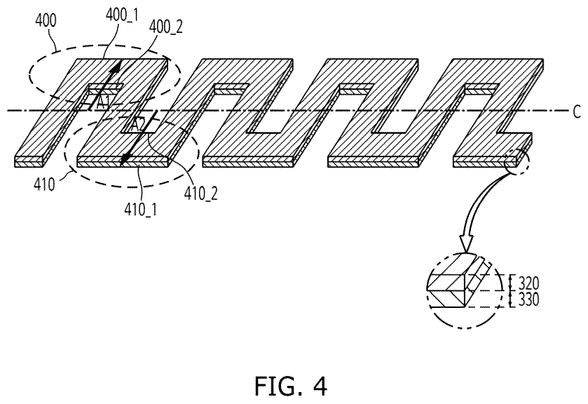

FIG. 4 illustrates a perspective view showing an example of a tape according to an embodiment of the present disclosure. FIG. 4 illustrates a diagram for describing the tape attached to the electrode assembly in FIG. 2. Hereinafter, a reference line c may be an imaginary line for describing the direction of the protrusion portion of the tape, and specifically, may be a line that divides the tape in the width direction.

In an embodiment, the tape may include a first protrusion portion 400 protruding in a first direction A1 and a second protrusion portion 410 connected to the first protrusion portion 400 and protruding in a second direction A2, as illustrated in FIG. 4. The first direction A1 may be a direction toward the top of the electrode assembly, and the second direction A2 may be a direction toward the bottom of the electrode assembly. The first protrusion portion 400 and the second protrusion portion 410 may be alternately disposed. In addition, an inner side 400_2 of the first protrusion portion may be positioned above the reference line c, and an inner side 410_2 of the second protrusion portion may be positioned below the reference line c (in the orientation of FIG. 2). The reference line c may be a line that divides the tape in the width direction. For example, the reference line c may be a line that divides the tape in half in the width direction, but the location of the line may vary.

In a case where the inner side 400_2 of the first protrusion portion of the tape is positioned above the reference line c and the inner side 410_2 of the second protrusion portion is positioned below the reference line c, the tape may flexibly flow according to the expansion and contraction of the electrode assembly in a case where the electrode assembly expands and contracts due to the charging and discharging of the secondary battery. That is, because the width of the connection portion between the first protrusion portion 400 and the second protrusion portion 410 becomes relatively thin, there may be relatively less restriction on the movement of the first substrate or the second substrate at the outermost portion of the electrode assembly. The movement may include an up-and-down movement in a direction approximately perpendicular to the first substrate or the second substrate.

Referring to FIG. 4, the tape may be composed of the substrate layer 320 and the adhesive layer 330, and the adhesive layer 330 may be disposed on one surface of the substrate layer 320. In this case, similar to the substrate layer 320, the adhesive layer 330 may be formed in the form in which the first protrusion portion 400 and the second protrusion portion 410 are alternately disposed above and below line c, as described above. The adhesive layer 330 may be an inner adhesive layer in contact with the outermost substrate of the electrode assembly or an outer adhesive layer in contact with the case of the secondary battery. However, in a case where the adhesive layer 330 in FIG. 4 is the outer adhesive layer, the inner adhesive layer may be disposed on the upper surface of the substrate layer 320.

In an embodiment, the shape formed by the outer side 400_1 of the first protrusion portion and the reference line c and the shape formed by the inner side 400_2 of the first protrusion portion and the reference line c may correspond to each other. The shape formed by the outer side 400_1 of the first protrusion portion and the reference line c and the shape formed by the inner side 400_2 of the first protrusion portion and the reference line c may be the same, but may be different in size. For example, as illustrated in FIG. 4, both the shape formed by the outer side 400_1 of the first protrusion portion and the reference line c and the shape formed by the inner side 400_2 of the first protrusion portion and the reference line c may be rectangular.

The description of the first protrusion portion 400 may also be applied to the second protrusion portion 410.

Referring to FIG. 4, in an embodiment, the shape formed by the outer side 410_1 of the second protrusion portion and the reference line c and the shape formed by the inner side 410_2 of the second protrusion portion and the reference line c may correspond to each other. That is, the two shapes may be the same, but the sizes thereof may be different. For example, both of the two shapes may be rectangular.

In the present disclosure, the outer side 400_1 or 410_1 or the inner side 400_2 or 410_2 of the first protrusion portion 400 or the second protrusion portion 410 may refer to sides forming the boundary of the tape. For example, in FIG. 4, the outer side 400_1 of the first protrusion portion may refer to two sides perpendicular to the reference line c and one side parallel to the reference line c.

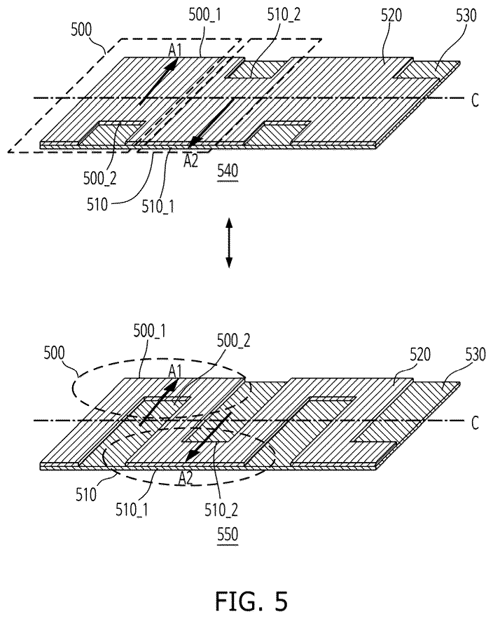

FIG. 5 illustrates a perspective view showing a tape according to one or more embodiments of the present disclosure. FIG. 5 illustrates a diagram for describing the tape attached to the electrode assembly in FIG. 2. In FIG. 5, in a case where the tape is attached to the electrode assembly, the first direction A1 may be a direction toward the top of the electrode assembly, and the second direction A2 may be a direction toward the bottom of the electrode assembly.

Referring to FIG. 5, in an embodiment 550, the inner adhesive layer 530 of the tape may further include a portion other than the portion overlapping the substrate layer 520 among the entire areas between the top end of the first protrusion portion 500 and the bottom end of the second protrusion portion 510. In a case where the shape of the substrate layer 520 is the same as described above with reference to FIG. 4, only the inner adhesive layer 530 may be disposed between the electrode assembly and the case in the area between the inner side 500_2 of the first protrusion portion and the bottom end of the second protrusion portion 510 and the area between the inner side 510_2 of the second protrusion portion and the top end of the first protrusion portion 500. The substrate layer 520 may flexibly flow according to the expansion and contraction of the electrode assembly and may flow together with the inner adhesive layer 530.

In the present disclosure, the top end of the first protrusion portion 500 may refer to not only a point or side of the top end of the first protrusion portion 500, but also an imaginary boundary line extending so that the point or side of the top end of the first protrusion portion 500 is parallel to the reference line c. The bottom end of the second protrusion portion 510 may refer to not only a point or side of the top end of the second protrusion portion 510, but also an imaginary boundary line extending so that the point or side of the top end of the second protrusion portion 510 is parallel to the reference line c.

In addition, the outer adhesive layer may further include a portion other than the portion overlapping the substrate layer 520 among the entire areas between the top end of the first protrusion portion 500 and the bottom end of the second protrusion portion 510. That is, the outer adhesive layer may have the same size and shape as the inner adhesive layer 530 as described above. In this case, the outer adhesive layer and the inner adhesive layer 530 may be disposed with the substrate layer 520 therebetween. The outer adhesive layer and the inner adhesive layer 530 may be larger than the substrate layer 520. The substrate layer 520 may flexibly flow according to the expansion and contraction of the electrode assembly and may flow together with the outer adhesive layer and the inner adhesive layer 530.

The inner adhesive layer 530 or the outer adhesive layer may be thinner than the substrate layer 520. The thickness of the adhesive layer 530 may be designed so as not to restrict the substrate layer 520 from flowing flexibly according to the expansion and contraction of the electrode assembly.

In one example 540, the substrate layer 520 may include a first protrusion portion 500 protruding in a first direction A1 and a second protrusion portion 510 connected to the first protrusion portion 500 and protruding in a second direction A2, as illustrated in FIG. 5. The first protrusion portion 500 and the second protrusion portion 510 may be alternately disposed. However, as in one example 540, in a case where the reference line c is a line that divides the substrate layer 520 in the width direction, an inner side 500_2 of the first protrusion portion is positioned below the reference line c, and an inner side 510_2 of the second protrusion portion is positioned above the reference line c, the width of the connection portion between the first protrusion portion 500 and the second protrusion portion 510 becomes relatively thick, and thus, the movement of the first substrate or the second substrate at the outermost portion of the electrode assembly may be relatively greatly restricted. The movement may include an up-and-down movement in a direction perpendicular to the first substrate or the second substrate due to the expansion and contraction of the electrode assembly. In the case of one example 540, stress due to the expansion and contraction of the first substrate or the second substrate during charging and discharging may not be alleviated.

In another example 550, the substrate layer 520 may include a first protrusion portion 500 protruding in a first direction A1 and a second protrusion portion 510 connected to the first protrusion portion 500 and protruding in a second direction A2, as illustrated in FIG. 5. The first protrusion portion 500 and the second protrusion portion 510 may be alternately disposed. In addition, an inner side 500_2 of the first protrusion portion may be positioned above the reference line c, and an inner side 510_2 of the second protrusion portion may be positioned below the reference line c. The reference line c may be a line that divides the substrate layer 520 in the width direction thereof. For example, the reference line c may be a line that divides the substrate layer 520 in half in the width direction, but the line may vary. In the case of example 550, stress due to the expansion and contraction of the first substrate or the second substrate during charging and discharging may be alleviated.

In order to ensure that the inner side 500_2 of the first protrusion portion of the substrate layer 520 is positioned above the reference line c and the inner side 510_2 of the second protrusion portion is positioned below the reference line c, the inner side 500_2 of the first protrusion portion and the inner side 510_2 of the second protrusion portion may be formed by removing a portion of the substrate layer 520 that is composed of the entire area between the top end of the first protrusion portion 500 and the bottom end of the second protrusion portion 510. For example, in a case where the reference line c is a line that divides the tape in half in the width direction, the length of the substrate layer 520 removed from the outer portion in the length direction, which may be the top end of the first protrusion portion 500 of the substrate layer 520 or the bottom end of the second protrusion portion 510, may satisfy Equation 1 below.

$$( length of tape in width direction ) \times 1 / 2 < ( removed length of tape ) < ( length of tape in width direction ) \qquad ( Equation 1 )$$

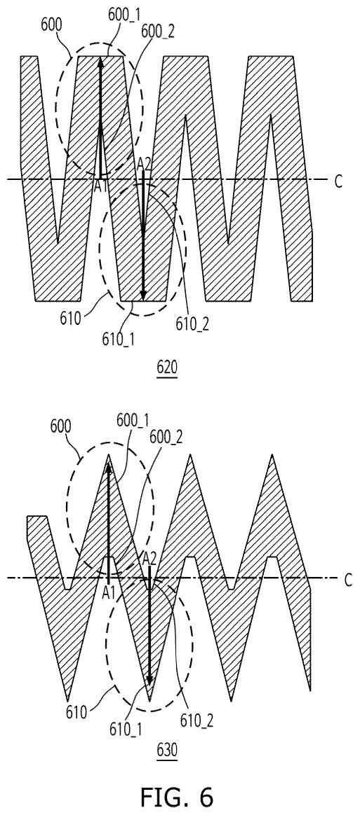

FIG. 6 illustrates a perspective view showing a tape according to one or more embodiments of the present disclosure. FIG. 6 illustrates a diagram for describing the tape attached to the electrode assembly in FIG. 2. FIG. 6 illustrates a diagram of the substrate layer of the tape, in a case where viewed from above. Descriptions redundant with those provided above are omitted.

Referring to FIG. 6, in an embodiment, in the case of a tape including a substrate layer and an inner adhesive layer, the shape and size of the substrate layer and the inner adhesive layer may be the same. Alternatively, the inner adhesive layer may cover the entire substrate layer and extend to an entire area between a top end of a first protrusion portion 600 and a bottom end of a second protrusion portion 610, as described with reference to FIG. 5.

In a case where the tape includes a substrate layer, an inner adhesive layer, and an outer adhesive layer, the substrate layer has the same shape as shown in FIG. 6, and the inner adhesive layer and the outer adhesive layer may have the same shape and size as those of the substrate layer. According to some other embodiments, the substrate layer may have the same shape as shown in FIG. 6, and the inner adhesive layer and/or the outer adhesive layer may extend to the entire area between the top end of the first protrusion portion 600 and the bottom end of the second protrusion portion 610, as described with reference to FIG. 5.

In an embodiment, an inner side 600_2 of the first protrusion portion is positioned above the reference line c, an inner side 610_2 of the second protrusion portion is positioned below the reference line c, and the shape formed by the outer side 600_1 of the first protrusion portion and the reference line c and the shape formed by the inner side 600_2 of the first protrusion portion and the reference line c may be different from each other. The reference line c may be a line that divides the substrate layer in the width direction. In some embodiments, the reference line c may be a line that divides the substrate layer in half in the width direction.

In some embodiments, the shape formed by the outer side 600_1 of the first protrusion portion and the reference line c and the shape formed by the inner side 600_2 of the first protrusion portion and the reference line c may be a triangular shape, a rectangular shape, a trapezoidal shape, a semicircular shape, or the like, but any shape that may be commonly adopted in the art may be possible as long as the shape may prevent crack occurrences and expansion of the first substrate or the second substrate of the electrode assembly.

In one example 620, the shape formed by the outer side 600_1 of the first protrusion portion and the reference line c may be a trapezoidal shape, and the shape formed by the inner side 600_2 of the first protrusion portion and the reference line c may be a triangular shape. In another example 630, the shape formed by the outer side 600_1 of the first protrusion portion and the reference line c may be a triangular shape, and the shape formed by the inner side 600_2 of the first protrusion portion and the reference line c may be a trapezoidal shape. The tapes according to the examples 620 and 630 may easily prevent the expansion of cracks that have already occurred in the first substrate or the second substrate of the electrode assembly.

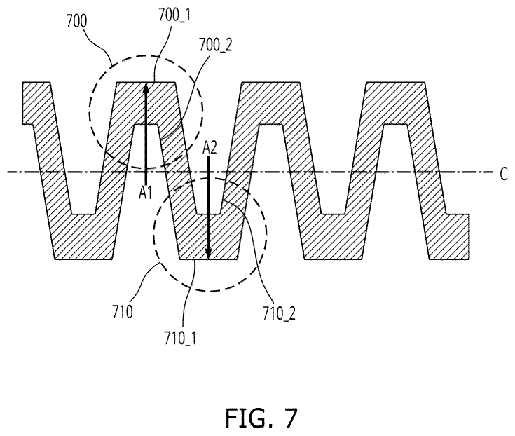

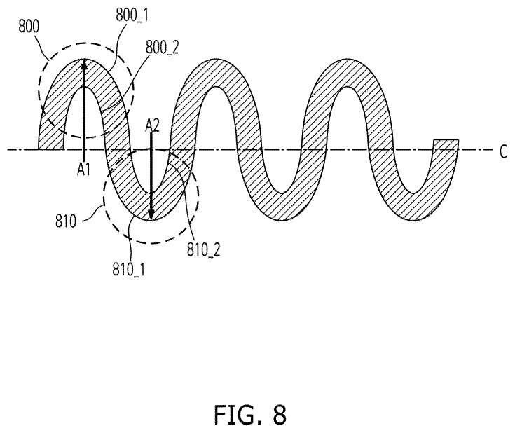

FIGS. 7 and 8 illustrate perspective views showing a tape according to an embodiment of the present disclosure. Descriptions redundant with those provided above are omitted.

The shape formed by an outer side 700_1 of the first protrusion portion and the reference line c and the shape formed by an inner side 700_2 of the first protrusion portion and the reference line c may correspond to each other (e.g., they may be the same shape). The shape formed by the outer side 700_1 of the first protrusion portion and the reference line c and the shape formed by the inner side 700_2 of the first protrusion portion and the reference line c may be the same, but may be different in size. For example, the shape formed by the outer side 700_1 of the first protrusion portion and the reference line c and the shape formed by the inner side 700_2 of the first protrusion portion and the reference line c may be the same as any one of a triangular shape, a rectangular shape, a trapezoidal shape, or a semicircular shape. The shape and size of the second protrusion portion 710 may be the same as the shape and size of the first protrusion portion 700. In the case of the tape illustrated in FIG. 7, both the shape formed by the outer side 700_1 of the first protrusion portion and the reference line c and the shape formed by the inner side 700_2 of the first protrusion portion and the reference line c may be trapezoidal. In the case of the tape illustrated in FIG. 8, both the shape formed by the outer side 800_1 of the first protrusion portion and the reference line c and the shape formed by the inner side 800_2 of the first protrusion portion and the reference line c may be semicircular.

In an embodiment, the shapes of the first protrusion portion and the second protrusion portion may be different from each other. For example, the shape formed by the outer side of the first protrusion portion and the reference line may be different from the shape formed by the outer side of the second protrusion portion and the reference line. In another embodiment, the shape formed by the inner side of the first protrusion portion and the reference line may be different from the shape formed by the inner side of the second protrusion portion and the reference line. As such, the protrusion portions of the tape may have various shapes to ensure that the tape has fluidity to prevent an occurrence of cracks in the electrode plates of the electrode assembly.

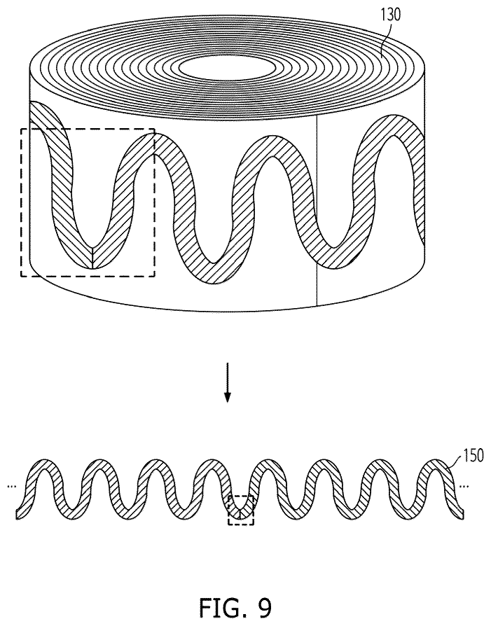

FIG. 9 illustrates a diagram for describing an overlapping portion of a tape according to an embodiment of the present disclosure.

In an embodiment, as illustrated in FIG. 9, a tape 150 may surround an electrode assembly 130 once, and opposite ends of the tape 150 may be in contact with each other. In this case, the contact portion may not overlap the finishing portion of the substrate indicated by a vertical line on the electrode assembly 130. According to an embodiment, in a case where opposite ends of the tape 150 attached to the initial electrode assembly 130 are in contact with each other, the opposite ends of the tape 150 may flow according to the expansion and contraction of the electrode assembly 130 so as not to be in contact on the outer circumferential surface of the electrode assembly 130.

As described above, in a case where opposite ends of the tape 150 are in contact with each other without overlapping, there is an advantage in that stress concentration on the substrate on the lower surface due to overlapping of the tape 150 may be prevented.

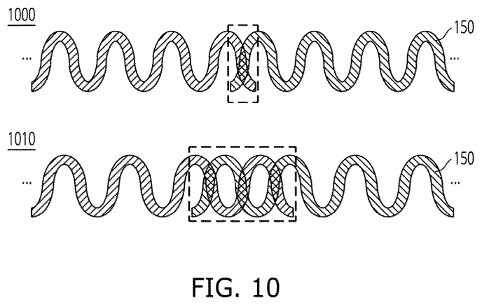

FIG. 10 illustrates a diagram for describing an overlapping portion of a tape according to some embodiments of the present disclosure. In FIG. 10, a case where the outer and inner sides of the first protrusion portion are in a semicircular shape relative to the reference line, but the shape and size thereof may be variable.

In an embodiment, the tape 150 may surround the electrode assembly more than once and may have an area where the tape 150 partially overlaps. The area where the tape 150 overlaps may refer to a case where at least two sides of the tape 150 overlap each other.

Referring to one example 1000, there may be one area (indicated by the broken-line rectangle) where the tape 150 partially overlaps. In a case where the tape 150 overlaps, as described with reference to FIG. 9, the prevention of unwinding of the electrode assembly may be performed more reliably, compared to a case where opposite ends of the tape 150 are in contact with each other.

Referring to another example 1010, there may be a plurality of areas where the tape 150 partially overlaps. For example, the number of overlapping areas of the tape 150 may be three (denoted by the broken-line rectangle), as shown in the example 1010. In this case, it may be easier to prevent unwinding compared to the example 1000. In addition, the portion where the tape 150 overlaps may be a portion where the first protrusion portion (e.g., 800 of FIG. 8) and the second protrusion portion (e.g., 810 of FIG. 8) are connected. The portion where the first protrusion and the second protrusion are connected may be a portion where the flow in the direction perpendicular to the substrate is the least, depending on the flow of the electrode assembly (e.g., 130 of FIG. 9). Therefore, even in a case where the tape 150 overlaps within the area, stress applied to the substrate may not reach a level to cause cracks.

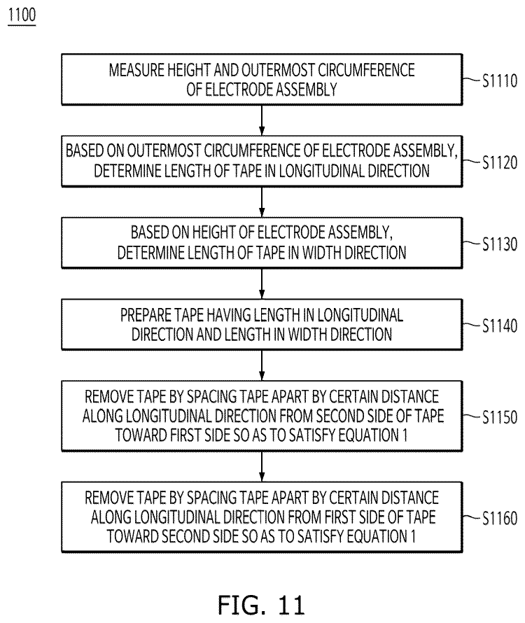

FIG. 11 illustrates a flowchart showing a method for manufacturing a tape for an electrode assembly according to one or more embodiments of the present disclosure. Descriptions redundant with those provided above are omitted.

A method 1100 for manufacturing a tape for an electrode assembly according to an embodiment of the present disclosure may be started by a step of preparing an electrode assembly formed by winding a laminate including a first electrode, a second electrode, and a separator interposed between the first electrode and the second electrode.

Next, the outermost circumference of the electrode assembly and the height between the top end and the bottom end of the electrode assembly may be measured (S1110). Next, based on the outermost circumference of the electrode assembly, the length of the substrate layer of the tape in the longitudinal direction may be determined (S1120). Based on the height of the electrode assembly, the length of the substrate layer of the tape in the width direction may be determined (S1130).

As described above, the tape having the determined length in the longitudinal direction and the determined length in the width direction may be prepared (S1140).

The tape may be removed by spacing the tape apart by a certain distance along the longitudinal direction from the second side of the tape toward the first side so as to satisfy Equation 1 (S1150). Then, the tape may be removed by spacing the tape apart by a certain distance along the longitudinal direction from the first side of the tape toward the second side so as to satisfy Equation 1 (S1160). The first side may refer to a side along the longitudinal direction of the tape prepared in step S1140, and the second side may refer to a side opposite to the first side. In an embodiment, the shape of the portion from which the tape is removed may be adjusted to have the shape of the substrate layer as described above. The first side may refer to the top end of the first protrusion portion in the present disclosure, and the second side may refer to the bottom end of the second protrusion portion in the present disclosure.

The portion in which the substrate layer of the tape is removed at regular intervals along the longitudinal direction from the second side to the first side to satisfy Equation 1 and the portion in which the substrate layer of the tape is removed at regular intervals along the longitudinal direction from the first side to the second side to satisfy Equation 1 may be alternately disposed.

The tape in FIG. 11 may refer to only the substrate layer of the tape. Therefore, the method may further include a step of additionally disposing an adhesive layer on at least one of the two surfaces of the substrate layer. The step of disposing the adhesive layer may include disposing the adhesive layer on the substrate layer in various sizes as described above. The adhesive layer may be attached to the substrate layer in the form of a film of a predefined size. The adhesive layer in the form of a film may have adhesive properties on opposite sides. In other embodiments, the adhesive layer may be applied to the substrate layer in the form of a paste having adhesive strength.

The flowchart of FIG. 11 and the above description are only examples of the present disclosure, and the scope of the present disclosure is not limited to the flowchart of FIG. 11 and the above description. For example, one or more steps in the flowchart and the above description may be added/changed/deleted, the order of one or more steps may be changed, and one or more steps may be performed simultaneously.

In an electrode assembly of a lithium-ion battery formed of electrodes and a separator, expansion and contraction of electrode plates may occur due to intercalation and deintercalation of lithium ions during charging and discharging. The outermost portion of the electrode assembly may be fixed by a finishing tape. In this case, a portion where the finishing tape is attached may accumulate stress in a case where the electrode plate expands and contracts due to a difference in thickness. Cracks may occur in the electrode plate along the boundary of the finishing tape due to stress applied to the electrode plate.

In a case where cracks occur in the electrode assembly, the output may decrease as resistance is concentrated at the cracked area and the amount of heat generated may increase significantly, thus increasing the risk of fire. In particular, there is a problem that the frequency of crack occurrence may be higher in models with high expansion and contraction rates due to charging and discharging of secondary batteries.

According to some embodiments of the present disclosure, the tape may flow in accordance with the expansion and contraction of the electrode plate.

According to some embodiments of the present disclosure, stress concentration at the interface between the tape and the electrode assembly may be alleviated during the charging and discharging of the secondary battery.

According to some embodiments of the present disclosure, the crack occurrence rate in the electrode plate at the interface between the tape and the electrode assembly during the charging and discharging of the secondary battery may be significantly reduced.

According to some embodiments of the present disclosure, the crack occurrence rate may be significantly reduced, thereby solving the problem of quality deterioration due to the reduced output of the secondary battery.

According to some embodiments of the present disclosure, the crack occurrence rate may be reduced, the resistance of the electrode plate may be reduced and the fire risk of the secondary battery may be reduced.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the present invention as set forth in the following claims.

### DESCRIPTION OF SOME REFERENCE SYMBOLS

100: secondary battery
110: case
120: cap assembly
122: terminal plate
124: cap plate
126: insulating member
128: insulating layer
130: electrode assembly
132: first electrode
134: second electrode
136: separator
142: first electrode tab
144: second electrode tab
150: tape
300, 310, 540, 550, 620, 630,1000, 1010: example
320, 520: substrate layer
330, 530: adhesive layer
c: reference line
400, 500, 600, 700, 800: first protrusion portion
410, 510, 610, 710, 810: second protrusion portion
A1: first direction
A2: second direction
400_1, 500_1, 600_1, 700_1, 800_1: outer side of first protrusion portion
400_2, 500_2, 600_2, 700_2, 800_2: inner side of first protrusion portion
410_1, 510_1, 610_1, 710_1, 810_1: outer side of second protrusion portion
410_2, 510_2, 610_2, 710_2, 810_2: inner side of second protrusion portion

What is claimed is:

1. A secondary battery, comprising:
a case;
an electrode assembly accommodated in the case, the electrode assembly comprising a winding of a first electrode, a second electrode, and a separator interposed between the first electrode and the second electrode; and
a tape surrounding an outermost portion of the electrode assembly along a winding direction, the tape comprising a first protrusion portion protruding in a first direction toward a top of the electrode assembly and a second protrusion portion connected to the first protrusion portion, the second protrusion portion protruding in a second direction toward a bottom of the electrode assembly, wherein:
the first protrusion portion and the second protrusion portion are alternated,
an inner side of the first protrusion portion is positioned above a reference line, and an inner side of the second protrusion portion is positioned below the reference line, and
the reference line divides the tape in a width direction.

2. The secondary battery as claimed in claim 1, wherein each of the first direction and the second direction is perpendicular to the winding direction of the electrode assembly.

3. The secondary battery as claimed in claim 1, wherein a shape of an outer side of the first protrusion portion and the reference line, and a shape of the inner side of the first protrusion portion and the reference line correspond to each other.

4. The secondary battery as claimed in claim 3, wherein the shape of the outer side of the first protrusion portion and the reference line, and the shape of the inner side of the first protrusion portion and the reference line are any one of a triangular shape, a rectangular shape, a trapezoidal shape, and a semicircular shape.

5. The secondary battery as claimed in claim 1, wherein a shape of an outer side of the first protrusion portion and the reference line, and a shape of an inner side of the first protrusion portion and the reference line are different from each other.

6. The secondary battery as claimed in claim 5, wherein the shape of the outer side of the first protrusion portion and the reference line is trapezoidal, and the shape of the inner side of the first protrusion portion and the reference line is triangular.

7. The secondary battery as claimed in claim 5, wherein the shape of the outer side of the first protrusion portion and the reference line is triangular, and the shape of the inner side of the first protrusion portion and the reference line is trapezoidal.

8. The secondary battery as claimed in claim 1, wherein the tape comprises a substrate layer and an inner adhesive layer, the inner adhesive layer being between the electrode assembly and the substrate layer.

9. The secondary battery as claimed in claim 8, wherein the tape further comprises an outer adhesive layer between the case and the substrate layer.

10. The secondary battery as claimed in claim 8, wherein the substrate layer comprises a polymer foam.

11. The secondary battery as claimed in claim 10, wherein the polymer foam comprises at least one of polyurethane resin, polyolefin resin, styrenic block copolymer, ethylene copolymer, acrylic block copolymer, acrylic acid ester copolymer, and halogenated polymer.

12. The secondary battery as claimed in claim 8, wherein the inner adhesive layer further comprises a portion other than a portion overlapping the substrate layer among entire areas between a top end of the first protrusion portion and a bottom end of the second protrusion portion.

13. The secondary battery as claimed in claim 9, wherein the outer adhesive layer further comprises a portion other than a portion overlapping the substrate layer among entire areas between a top end of the first protrusion portion and a bottom end of the second protrusion portion.

14. The secondary battery as claimed in claim 1, wherein the tape surrounds the electrode assembly once, and opposite ends of the tape are in contact with each other.

15. The secondary battery as claimed in claim 1, wherein the tape surrounds the electrode assembly at least once and has an area where the tape partially overlaps itself.

16. The secondary battery as claimed in claim 15, wherein the area where the tape partially overlaps is provided in plurality.

17. The secondary battery as claimed in claim 1, wherein the secondary battery comprises a coin cell, a cylindrical cell, or a pin cell.

18. The secondary battery as claimed in claim 1, wherein the reference line divides the tape in half in the width direction.

19. The secondary battery as claimed in claim 1, wherein a shape of the first protrusion portion is different than a shape of the second protrusion portion.

20. A battery module comprising a plurality of the secondary battery as claimed in claim 1, resulting in secondary batteries, wherein the secondary batteries are electrically connected to each other.
